(19) United States
(12) Patent Application Publication
(10) Pub. No.: US 2018/0015622 A1
(43) Pub. Date: Jan. 18, 2018

(54) ROTARY CUTTING DEVICE

(71) Applicant: HP INDIGO B.V., Amstelveen (NL)

(72) Inventors: Itzik Kent, Ness Ziona (IL); Avihay Menashe, Ness Ziona (IL); Ilan Meiri, Yavne (IL)

(73) Assignee: HP INDIGO B.V., Amstelveen (NL)

(21) Appl. No.: 15/545,928

(22) PCT Filed: Mar. 27, 2015
(86) PCT No.: PCT/EP2015/000663

§ 371 Date: Jul. 24, 2017

(51) Int. Cl. B26D 1/40; B26D 5/02; B26D 7/26; B26D 5/32; B26D 1/62; B26D 3/08; B26F 1/08; B26D 1/00

(52) U.S. Cl. CPC B26D 1/405; B26D 5/02; B26D 2007/2692; B26D 2001/0073; B26D 1/626; B26D 3/08; B26F 1/08; B26D 5/32

(57) ABSTRACT

In one example, a rotary cutting device includes a helical cutting blade rotatable against a workpiece to cut the workpiece and translatable to engage the workpiece and to disengage the workpiece.

### BACKGROUND

Printed materials may undergo post print finishing operations including, for example, shearing, perforating and scoring.

### DRAWINGS

FIGS. 1 and 2 are perspective and end views, respectively, illustrating one example of a rotary cutting device, such as might be used with a digital printer to perforate, score, shear or otherwise cut a web or sheet of printed material.

FIGS. 3-14 depict a series of views illustrating one example of a process for making a cut using the cutting device shown in FIGS. 1 and 2.

FIG. 15 is a flow diagram illustrating one example of a cutting process such as that shown in FIGS. 3-14.

FIG. 16 is a plan view diagram illustrating one example for cutting a moving workpiece.

FIG. 17 is a block diagram illustrating one example of a rotary cutting device with a controller to control the translation and rotation of a cutting head.

FIGS. 18 and 19 illustrate other examples of a rotary cutting device.

The same part numbers designate the same or similar parts throughout the figures. The figures are not necessarily to scale.

### DESCRIPTION

Currently, in a rotary perforating device the length of a perforation across a web or sheet of printed material moving through the device is controlled by the length of a blade mounted on a rotating shaft. In some perforating devices, the perforating blades are mounted on the shaft in segments. The length of the perforation may be varied by changing a single blade segment or by combining multiple blade segments on the shaft. In either case, the device is stopped to change the length of the perforation.

Digital printers are used to advantage printing shorter “runs” in which a comparatively few items are printed in each run. Frequently starting and stopping a perforating device to change blades (or blade segments) for shorter runs in digital printing results in considerable device downtime. More downtime means lower production and higher costs. For inline perforating, in which materials are perforated as part of the printing process, stopping the perforating device means stopping the printer, resulting in even higher production costs.

A new rotary perforating device has been developed for use with digital printers to help reduce the time needed to change the length of a perforation across printed material. In one example, a perforating device includes a helical perforating blade that is both rotatable against printed material to make the perforation and translatable into and away from the material to begin and end the perforation—the rotating blade is translated toward the material to engage the material to begin the perforation and translated away from the material to disengage the material to end the perforation. In this and other examples, the length and position of a perforation across a moving material may be changed automatically, without stopping the rotating blade or the moving material, by timing the engagement to start the perforation and by timing the disengagement to end the perforation.

Examples are not limited to perforating devices or to use with printed materials, but may be implemented in other cutting devices and for use with other workpieces. The examples shown in the figures and described herein illustrate but do not limit the scope of the patent, which is defined in the Claims following this Description.

As used in this document, “anvil” means an object against which a blade is engaged to cut a workpiece placed between the blade and the anvil; “cut” means to penetrate with or as if with an edged instrument, including shearing, perforating and scoring; “rotate” means to turn about an axis; “translate” means to move in a straight line; and a “workpiece” means an object being worked on or to be worked on by a tool or device.

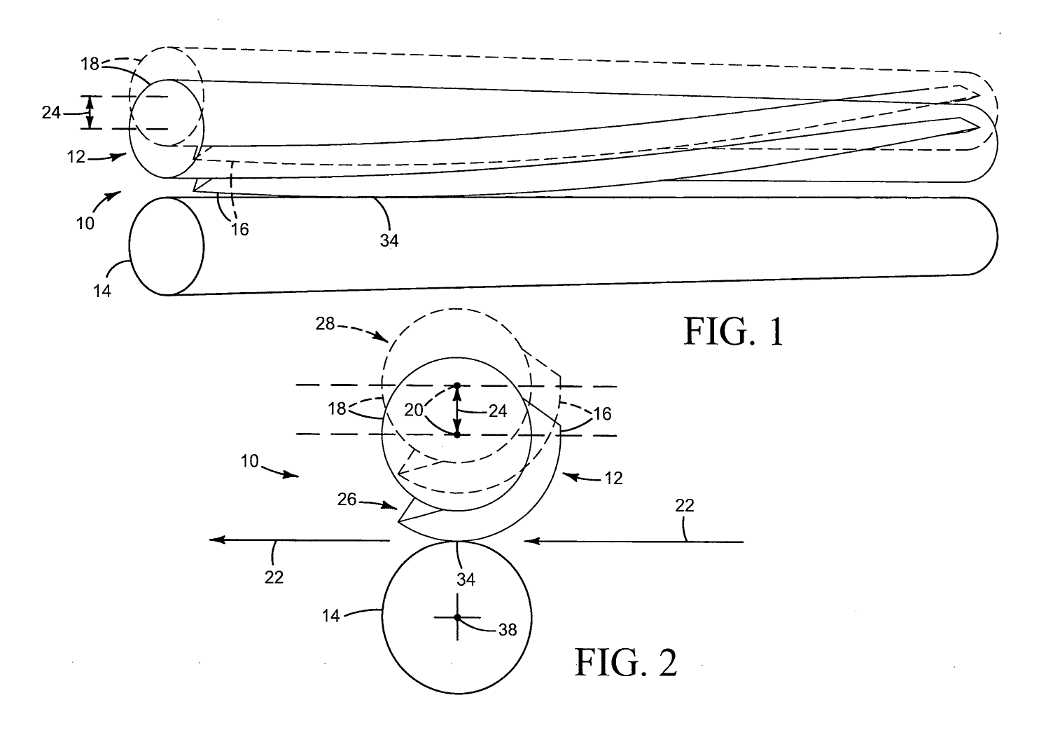

FIGS. 1 and 2 are perspective and end views, respectively, illustrating one example of a rotary cutting device 10, such as might be used with a digital printer to perforate, score, shear or otherwise cut a web or sheet of printed material. Referring to FIGS. 1 and 2, cutting device 10 includes a cutting head 12 and an anvil 14 located opposite cutting head 12. Cutting head 12 includes a helical cutting blade 16 mounted on a shaft 18. Shaft 18 rotates on an axis of rotation 20 that extends laterally across a path 22 followed by a workpiece (not shown) moving through cutting device 10. Shaft 18 also translates toward and away from anvil 14 radially along a line 24 perpendicular to axis 20. Shaft 18 translates between an engaged position 26 in which blade 16 contacts anvil 14, depicted with solid lines in FIGS. 1 and 2, and a disengaged position 28 in which blade 16 does not contact anvil 14, depicted with dashed lines in FIGS. 1 and 2.

A helical blade 16 engages anvil 14 at a single point of contact 34 that moves laterally across path 22 as shaft 18 rotates. The rotational speed of shaft 18 and the pitch of blade 16 determine the rate at which point of contact 34 moves across path 22. A cut is started by translating a rotating blade 16 into engagement with anvil 14 at the rotational position of blade 16 corresponding to the desired start location. A cut is ended by translating the rotating blade 16 out of engagement with anvil 14 at the rotational position of blade 16 corresponding to the desired end location.

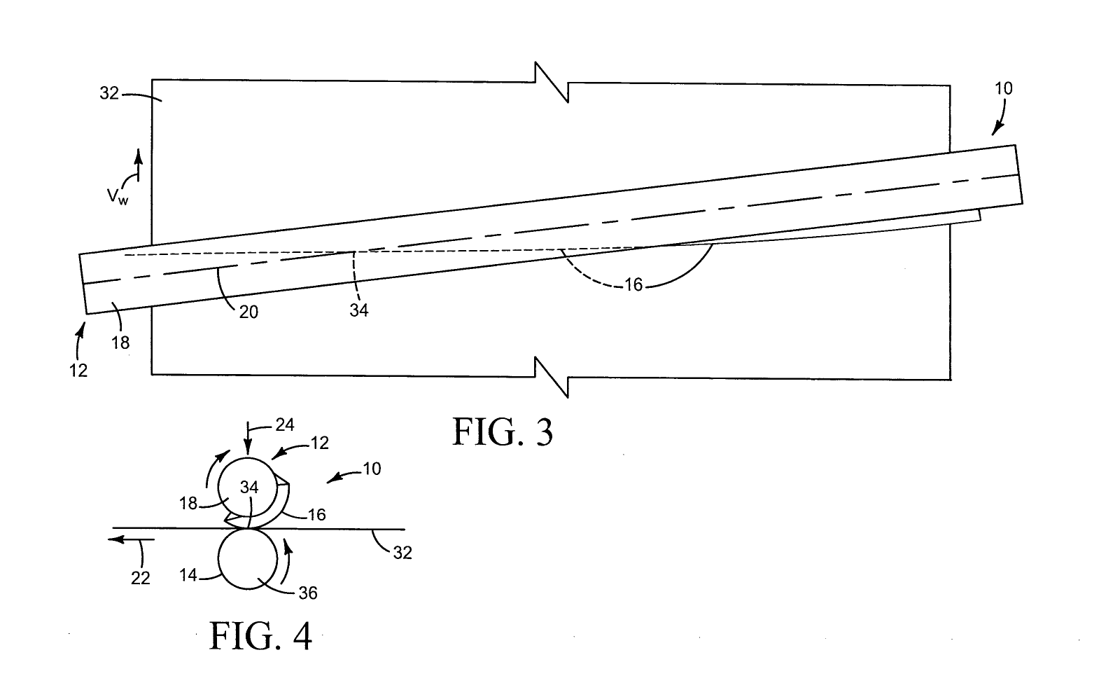

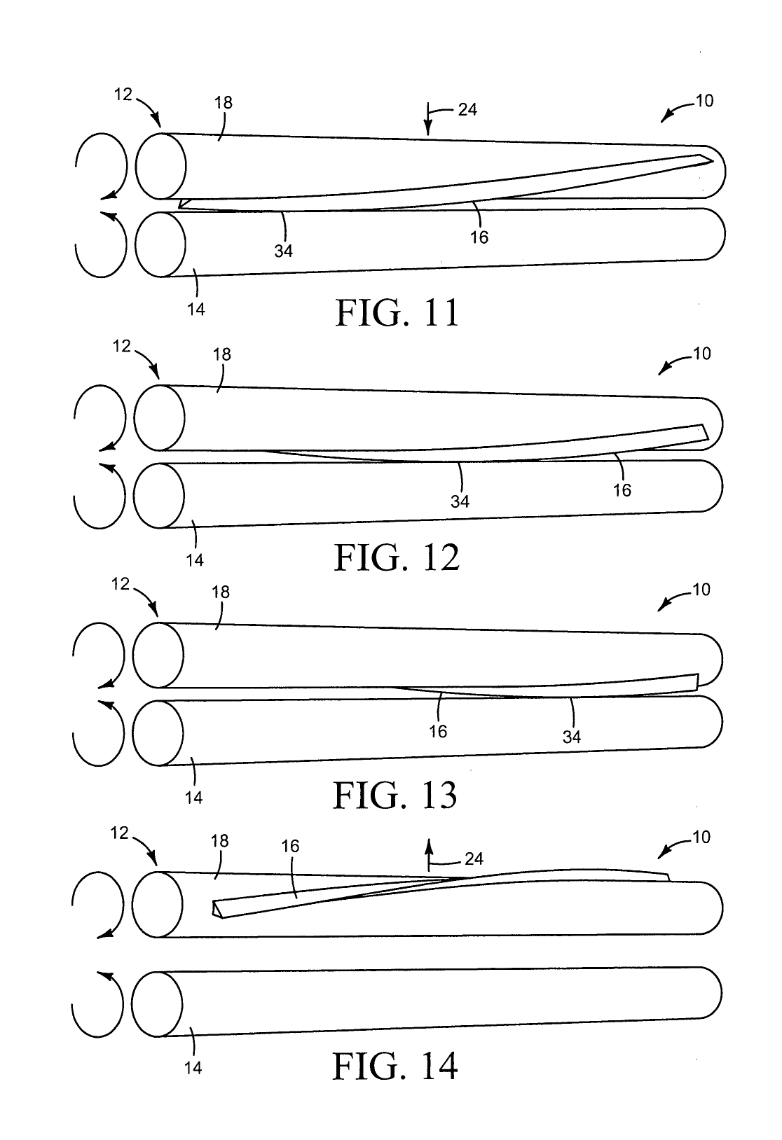

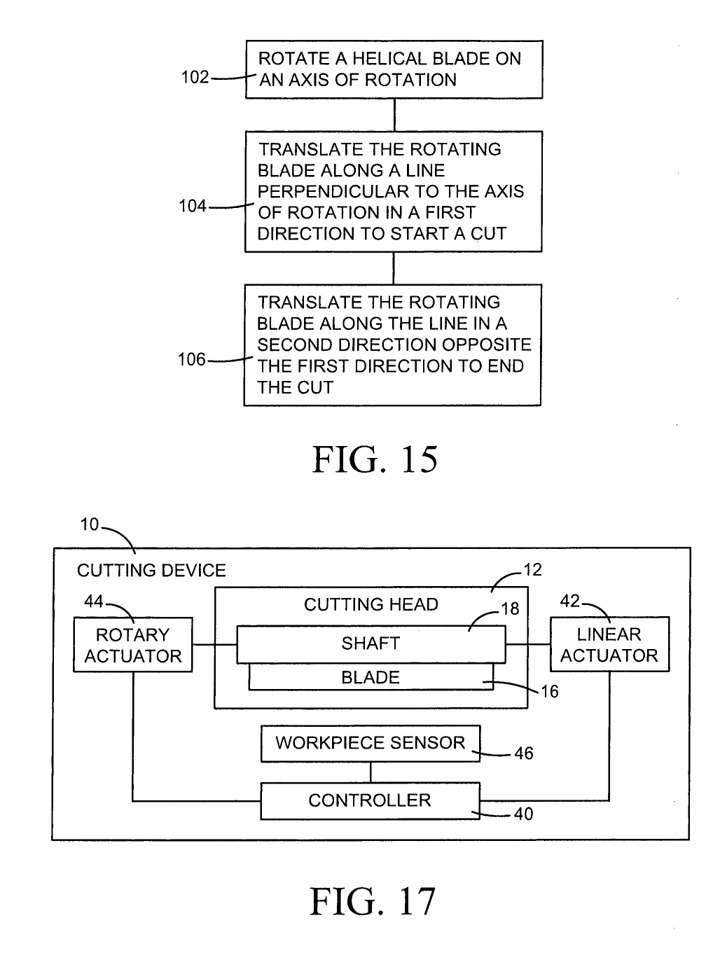

A series of plan and end views in FIGS. 3-10 illustrate one example of a process for making a cut 30 in a workpiece 32 using the cutting device 10 shown in FIGS. 1 and 2. Workpiece 32 is moving over anvil 14 along path 22 in FIGS. 3-10. FIGS. 11-14 are perspectives corresponding to the position of cutting head 12 and anvil 14 shown in the plan and end views of FIGS. 3-4, 5-6, 7-8, and 9-10. Workpiece 32 is omitted from FIGS. 11-14 for clarity. FIG. 15 is a flow diagram illustrating one example of a cutting process such as the one shown in FIGS. 3-14.

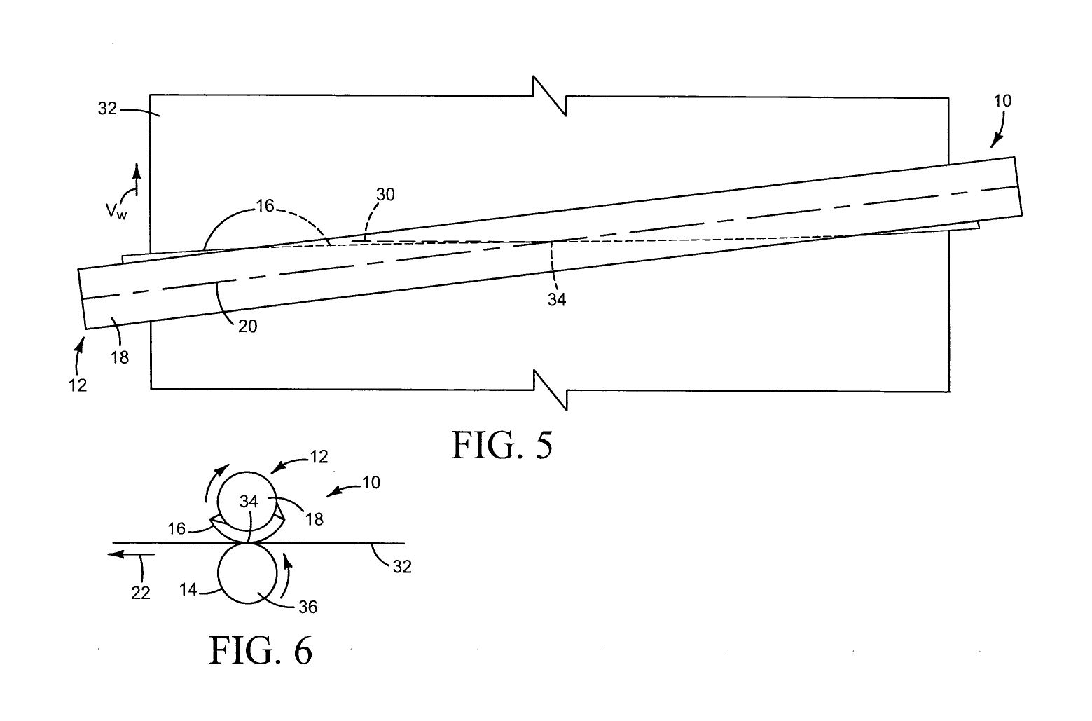

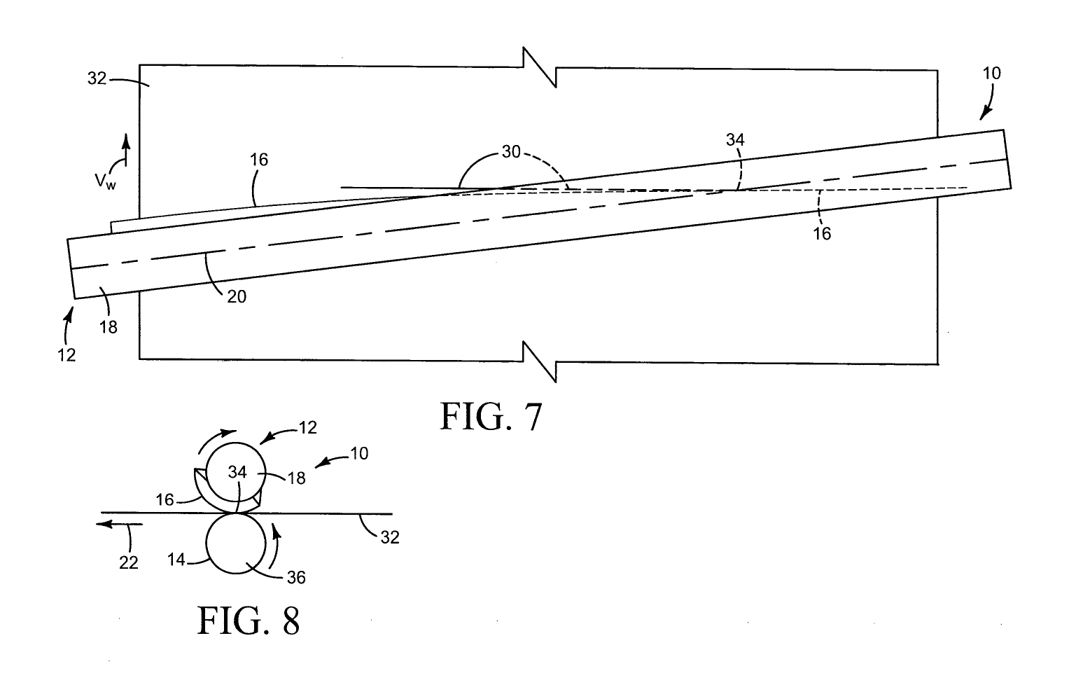

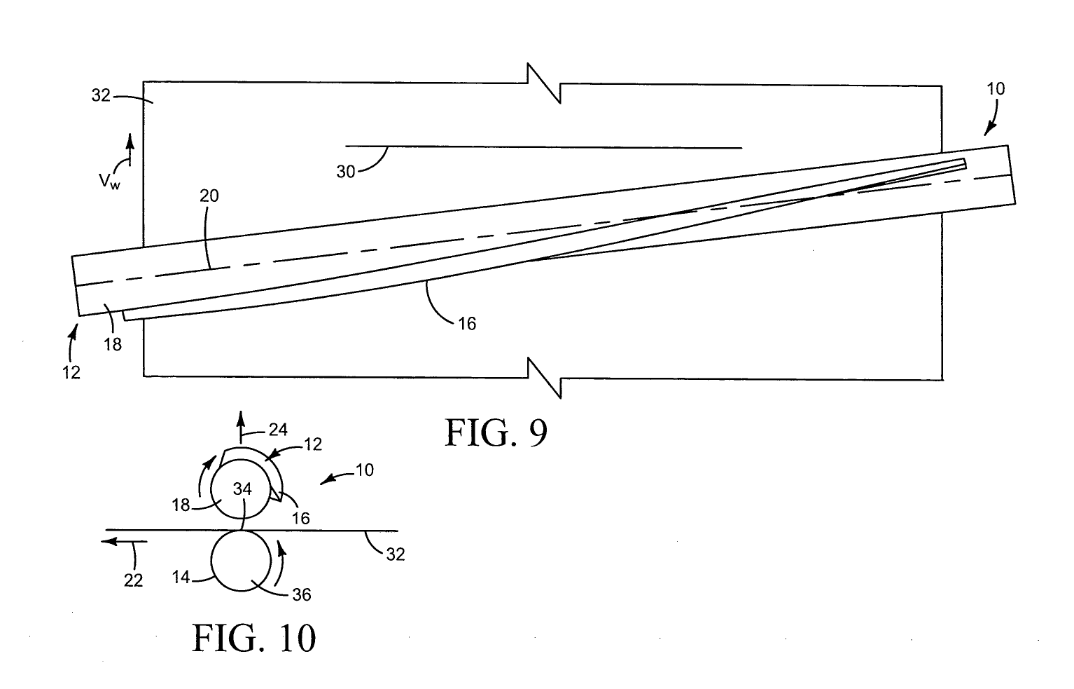

With shaft 18 rotating and blade 16 disengaged from anvil 14, the rotating shaft 18 is translated along line 24 until blade 16 engages anvil 14 to begin cut 30, as shown in FIGS. 3-4 and 11 (blocks 102 and 104 in FIG. 15). The location of the start of cut 30 laterally across workpiece 32 is determined by the rotational position of shaft 18 (and thus blade 16) at the time blade 16 engages anvil 14 at contact point 34. As shaft 18 continues to rotate with blade 16 engaged against anvil 14, contact point 34 advances across workpiece 32 to continue cut 30, as shown in FIGS. 5-6 and 12. Upon reaching the desired location for the end of the cut, shown in FIGS. 7-8 and 12, the rotating shaft 18 is translated along line 24 away from anvil 14 to disengage blade 16 and end cut 30 (block 106 in FIG. 15). The location of the end of cut 30 is determined by the rotational position of shaft 18 (and thus blade 16) at the time blade 16 disengages anvil 14. FIGS. 9-10 and 13 show blade 16 disengaged from anvil 14 after ending cut 30.

“Engage” as used in this context includes: actual and continuous contact between blade 16 and anvil 14, for example to make a shearing cut 30; actual but intermittent contact between blade 16 and anvil 16, for example to make a perforating cut 30; or sufficient pressure applied by blade 16 against anvil 14 without actual contact, for example to make a scoring cut 30. Similarly, a “point of contact” as used in this context includes: a point of actual contact between blade 16 and anvil 14 that moves continuously across anvil 14, for example to make a shearing cut 30; a point of actual but intermittent contact between blade 16 and anvil 16, for example to make a perforating cut 30; and a projected point of contact between blade 16 and anvil 14, for example to make a scoring cut 30.

In the example shown, anvil 14 is configured as a counter-rotating shaft 36 that may be used to help advance contact point 34 smoothly across a moving workpiece 32 for a cleaner cut. Although anvil 14 and shaft 36 are depicted in the figures as a single integral unit, anvil 14 may be a separate part carried by shaft 36. In either case, it may be said that shaft 36 carries anvil 14 where anvil 14 is itself the object against which blade 16 is engaged to make a cut. Anvil shaft 36 rotates on an axis 38 that is parallel to the axis of rotation 20 for shaft 18 and blade 16. Other suitable configurations for an anvil 14 are possible. Also, while rotation axes 20 and 38 are horizontal and translation line 24 is vertical in this example, other suitable orientations are possible.

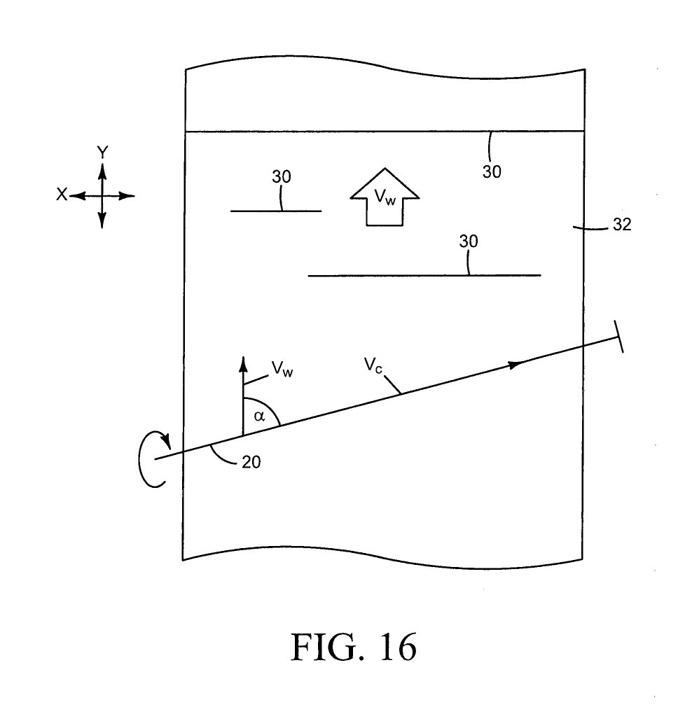

Referring now to the diagram of FIG. 16, the motion of contact point 34 (FIGS. 3-14) is indicated by V_{C} and the motion of workpiece 32 is indicated V_{W}. The rotational axis 20 of cutting head 12 is oriented at an angle a with respect to the direction of motion of workpiece 32. The contact point is driven along at a speed V_{C} and at angle a sufficient to make a straight cut 30 across the moving workpiece 32. (Several different cuts 30 are shown on workpiece 32 in FIG. 16.) The speed at which the contact point advances across workpiece 32 is determined by the pitch of the helical blade and the rotational speed of the shaft carrying the blade. Where the speed V_{W} of workpiece 32 is constant, the speed V_{C} of the contact point and thus the cut angle Θ is controlled by the rotational speed of the shaft. While it is expected that the cut line usually will be perpendicular to the direction the workpiece moves through the cutting device (Θ=90°), other cut line orientations are possible.

FIG. 17 is a block diagram illustrating one example of a cutting device 10 with a controller 40 to control translation and rotation of cutting head 12. Referring to FIG. 17, cutting device 10 includes a stepper motor or other suitable linear actuator 42 to translate shaft 18 and a variable speed motor or other suitable rotary actuator 44 to rotate shaft 18. Cutting device 10 may also include a workpiece sensor 46 (or multiple sensors 46) to sense the presence of a workpiece in the cutting device and to sense characteristics of the workpiece. For example, for cutting a printed material workpiece, an optical sensor 46 may be used to detect registration marks printed on the workpiece to determine the size, location and speed of the workpiece.

Controller 40 is operatively connected to actuators 42, 44 and sensor(s) 46 to control the translation and rotation of shaft 18 and thus blade 16. Controller 40 includes the programming, processors and associated memories, and the electronic circuitry and components needed to control actuators 42, 44 and other operative elements of cutting device 10. Controller 40 may include, for example, an individual motor controller for each actuator 42, 44 operating at the direction of a programmable microprocessor that receives signals or other data from sensor(s) 46 to generate drive parameters for actuators 42, 44 to make the desired cuts.

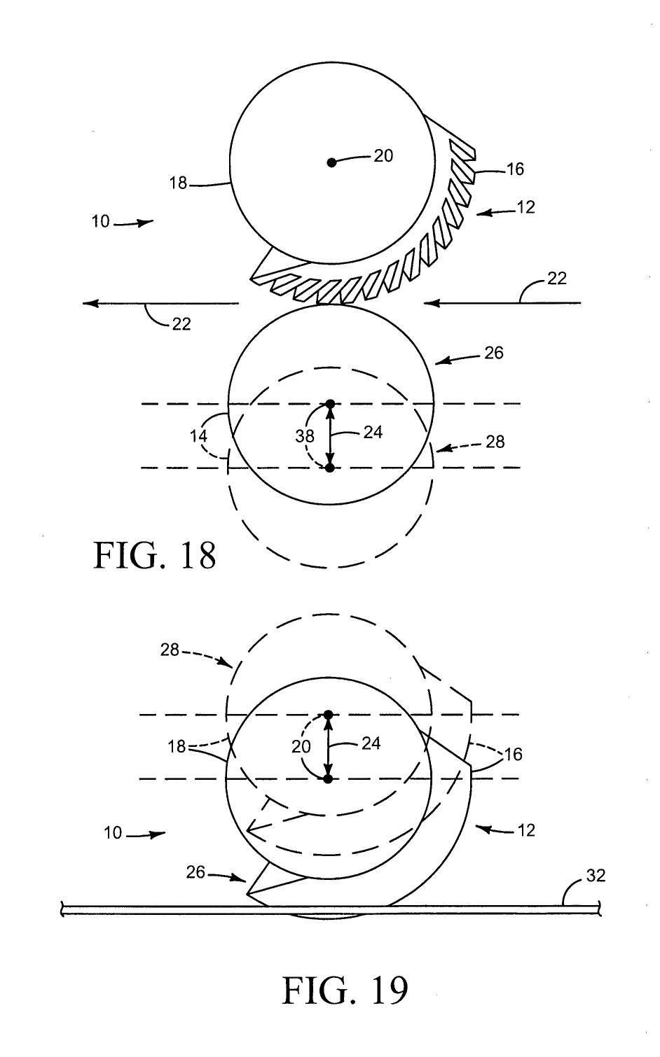

In another example of a cutting device 10, shown in FIG. 18, cutting head 12 is translationally stationary and anvil 14 translates to engage and disengage blade 16. Referring to FIG. 18, anvil 14 is configured as a shaft that translates toward and away from cutting head 12 along line 24 perpendicular to rotation axes 20, 38. Anvil 14 translates between an engaged position 26 in which anvil 14 contacts blade 16, depicted with solid lines in FIG. 18, and a disengaged position 28 in which anvil 14 does not contact blade 16, depicted with dashed lines in FIG. 18. In this example, blade 16 is configured as a perforation cutting blade with a stepped edge.

In another example of a cutting device 10, shown in FIG. 19, cutting head 12 operates on a workpiece 32 without an anvil. A no-anvil implementation such as that shown in FIG. 19 may be desirable, for example, for workpieces 32 that can sustain a cut without underlying support along the cut line.

Examples of a cutting device 10 such as those shown in the figures and described above enable a cut 30 to be made automatically in the desired length and position across different size workpieces 32 without stopping the cutting head or the workpiece. The engagement and disengagement of blade 16 and anvil 14 are timed to correspond to the start and end of the cut, respectively, according to the linear speed and location/size of the workpiece and the rotational speed of the blade. A single blade 16 spanning the widest possible workpiece 32 can be used to make different length cuts across different size workpieces.

As noted at the beginning of this Description, the examples shown in the figures and described above illustrate but do not limit the scope of the patent. Other examples are possible. Therefore, the foregoing description should not be construed to limit the scope of the patent, which is defined in the following Claims.

“A” and “an” as used in the Claims means one or more.

What is claimed is:

1. A rotary cutting device, comprising a helical cutting blade rotatable against a workpiece to cut the workpiece and translatable to engage the workpiece and to disengage the workpiece.

2. The device of claim 1, comprising a rotary actuator to rotate the blade and a linear actuator to translate the blade.

3. The device of claim 1, where the blade is rotatable on an axis of rotation and translatable in a direction perpendicular to the axis of rotation to engage and disengage the workpiece.

4. The device of claim 1, where the blade is rotatable against the workpiece at a single point of contact that advances across the workpiece as the blade rotates.

5. The device of claim 1, where the blade comprises a perforation cutting blade.

6. The device of claim 1, comprising a controller to cause the blade to engage the workpiece, to rotate against the workpiece, and to disengage the workpiece.

7. The device of claim 1, comprising an anvil, the blade rotatable against the anvil to cut a workpiece positioned between the blade and the anvil and the blade translatable to engage the anvil and to disengage the anvil.

8. A rotary cutting device, comprising:
a cutting blade;
an anvil opposite the blade;
a first rotatable shaft carrying one of the blade or the anvil and having a first axis of rotation, the blade and the anvil engage-able at a single point of contact that moves as the first shaft rotates; and
a controller to engage the blade and the anvil to start a cut, to rotate the first shaft while the blade and the anvil are engaged to make the cut, and to disengage the blade and the anvil to end the cut.

9. The device of claim 8, where the blade comprises a helical blade and the first shaft carries the helical blade to move the point of contact.

10. The device of claim 8, where the controller is to engage the blade and the anvil while rotating the first shaft.

11. The device of claim 8, comprising a second rotatable shaft carrying the other of the blade or the anvil and having a second axis of rotation parallel to the first axis of rotation.

12. The device of claim 11, where the controller is to disengage the blade and the anvil while rotating the first shaft.

13. A process for cutting a workpiece, comprising:
rotating a helical blade on an axis rotation;
translating the rotating blade along a first line in a first direction perpendicular to the axis of rotation to start a cut in the workpiece; and
translating the rotating blade along the first line in a second direction opposite the first direction to end the cut in the workpiece.

14. The process of claim 13, comprising moving the workpiece along a second line perpendicular to the axis of rotation and perpendicular to the first line while making the cut.

15. The process of claim 13, comprising:
engaging an anvil to start the cut; and
disengaging the anvil to end the cut.
